(19) United States
(12) Patent Application Publication
(10) Pub. No.: US 2024/0375205 A1
(43) Pub. Date: Nov. 14, 2024

(54) WELDING DEVICE FOR WIRE MESHES

(71) Applicant: EVG ENTWICKLUNGS- U. VERWERTUNGS-GESELLSCHAFT M.B.H., Raaba (AT)

(72) Inventor: Mathias HAIDBAUER, Hartberg (AT)

(21) Appl. No.: 18/692,085

(22) PCT Filed: Sep. 15, 2022
(86) PCT No.: PCT/IB2022/058721

§ 371 Date: Mar. 14, 2024

(30) Foreign Application Priority Data
Sep. 15, 2021 (AT) A 50725/2021

(51) Int. Cl. B23K 11/00

(52) U.S. Cl. CPC B23K 11/008

(57) ABSTRACT

A welding device for wire meshes which extend in a plane with a predefined width and have meshes, wherein said welding device comprises multiple electrodes which are connected to transformers via current paths.

### FIELD

The invention relates to a welding device for wire meshes which extend in a plane with a predefined width and have meshes, wherein the welding device comprises multiple electrodes which are connected to transformers via current paths.

### BACKGROUND

Prior art consists in the introduction of electrical energy into welding machines for the production of industrial mesh and fence mesh mats by means of medium-frequency welding via continuous busbars for the positive and negative poles (the circuit is closed via the welding transformer on the one hand and via the welding electrodes via the intersecting longitudinal and transverse bars which are to be welded together on the other). A wide variety of designs are known, wherein essential elements of the welding apparatus are arranged both above the mesh production plane and below the mesh production plane.

### SUMMARY

The invention is intended to reduce the energy requirement for welding, to be cost-effective, maintenance-friendly and to reduce the adjustment times of a welding machine. Furthermore, the quality of the welds is to be improved and harmonized.

The welding device according to the invention achieves this in that two busbars are connected between all current paths and transformers, which busbars extend on one side of the plane essentially over the width of a wire mesh mat, wherein the busbars are firmly connected to an interposed insulator to form a sandwich, and wherein multiple lines lead from a first group of current paths to electrodes located on the same side of the plane and from a second group of current paths multiple lines lead to electrodes located on the opposite side of the plane.

In a further embodiment, the busbars have bridges arranged alternately along their extension, which are connected between the transformers and the busbars for energy input.

In an alternative embodiment, the lines to the electrodes are designed as elongated plates the plane of which extends in the spaces between parallel longitudinal wires which can be welded in the welding device.

In yet another embodiment, the transformers are medium-frequency transformers.

It is also conceivable that the busbars are connected to the plates via elastic path pieces and that the plates can be driven movably from and to the mesh plane.

In a further embodiment, the electrodes are combined in multiple assemblies comprising at least two opposing electrodes, each assembly being electrically connected to a line.

### BRIEF DESCRIPTION OF THE DRAWINGS

The invention is explained in more detail below with reference to the drawings:

FIG. 1 is a side view of the welding device according to the invention;

FIG. 2 is a perspective view thereof;

FIGS. 3A to 5A are further perspective views of other embodiments.

### DETAILED DESCRIPTION

Wire mesh mats that are produced in an automated method extend in a plane E in the X and Y directions, wherein a set of longitudinal wires LD is fed in the X direction and the welded wire mesh mat is pulled out in the same X direction behind a welding portal. The required welding device extends in the Y direction along the width of a wire mesh mat and feeds electrodes 7 to the longitudinal wires LD intermittently in the Z direction perpendicular to the X and Y directions in order to weld them with prepared transverse wires QD.

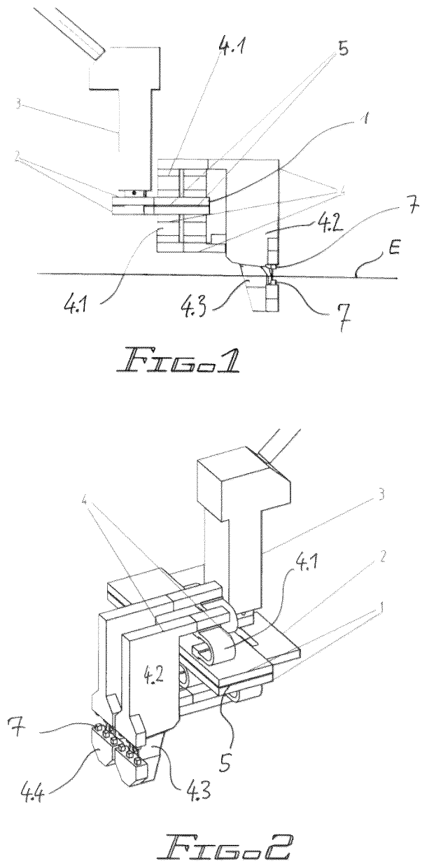

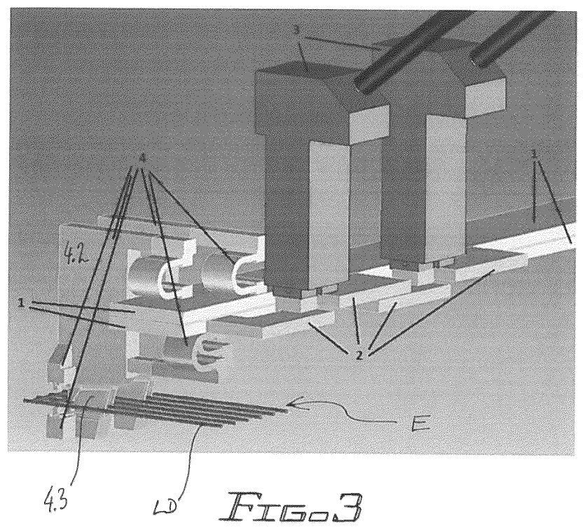

According to FIG. 1, almost all mechanical and current-carrying elements of the welding device are now located on only one side of the plane E. Whether the desired side is above or below plane E is not relevant to the invention. In the example shown, the welding device is essentially located graphically above plane E.

The electrodes 7, which are necessarily arranged on both sides, i.e. opposite each other, are connected to transformers 3 via current paths 4. As there must be a large number of pairs of electrodes 7 across the width of the mat, the current paths 4 are connected to the transformers 3 via two busbars 1 of both polarities. Each busbar 1 is provided for a group of the upper or lower electrodes 7. The busbars 1 are firmly connected together with an interposed insulator 5 to form a sandwich. This creates spatial compactness, which is advantageous in wire mesh welding systems with many (not shown) bulky mechanical elements.

As also shown in FIG. 2, bridges 2 project alternately from both busbars 1 in order to provide the necessary contacts to the transformers 3. The bridges 2 of the two busbars 1 are sufficiently large in view of the electrical specifications and are spaced sufficiently far apart. In this way, the outer surfaces of the busbars 1 remain free to provide space for the numerous required current paths 4 of the electrodes 7.

A current path 4 comprises copper as usual; it is also designed in such a way that it complies with the electrotechnical specifications, i.e. has sufficiently large conductor cross-sections, is at least partially movable in order to intermittently move the electrodes 7 to the weld metal, and utilizes the few available spaces in the production process of wire mesh mats. To achieve this, an elastic path piece 4.1 first leads away from the busbars 1 and is then connected to a plate 4.2 for upper electrodes or to a plate 4.3 for electrodes 7 on the opposite side. The plates 4.3 for the electrodes 7 located opposite or below plane E pass through spaces formed by the parallel longitudinal wires LD that are fed in. In order to achieve the required cross-sections, this part of the current path 4 is designed as a plate 4.3 lying parallel to the longitudinal wires LD. For the corresponding portions of the current path 4 of the upper electrodes 7, plates 4.2 are also provided in parallel in accordance with the invention.

From there on, the current path 4 merges into assemblies 4.4, each of which has one to several, preferably three, electrodes 7 on each side. The assemblies 4.4 also form pairs on both sides of the mesh plane. The bundling ensures uniform current distribution and a mechanically consistently controllable contact pressure during welding, which results in high quality and uniformity among the welds.

The dimensions of plates 4.2 and 4.3 are designed according to specifications and considerations with regard to the current and voltage values, the uniformity between them with regard to the welding result and the mesh of the longitudinal wires LD (distance between the longitudinal wires LD). The dimensions can be different between each other or between groups of upper and lower electrodes 7. In any case, however, it is advantageous to design this part of the copper path with the geometry of plates, the plane of which is aligned along the axes of the longitudinal wires LD and which, in the case of a group of electrodes 7, extend in the spaces between longitudinal wires LD.

For the electrodes 7 to also reach the transverse wires QD, without the current path 4 interfering spatially, the electrodes 7 are not positioned centrally on a plate 4.2, 4.3, but are arranged essentially over the assemblies 4.4 at one corner. This allows the plates 4.2, 4.3 to extend at the location where un-welded longitudinal wires LD are fed and the required spaces are still present. These spaces are then filled by the inserted transverse wires QD and can no longer be used.

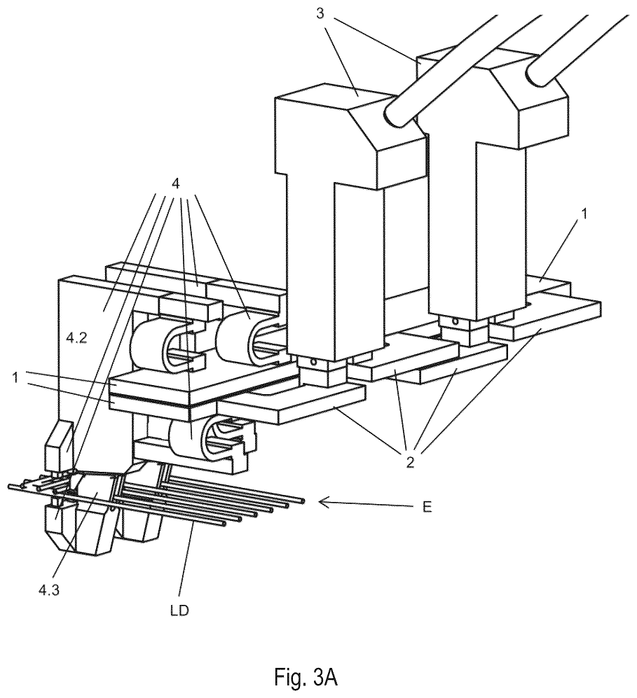

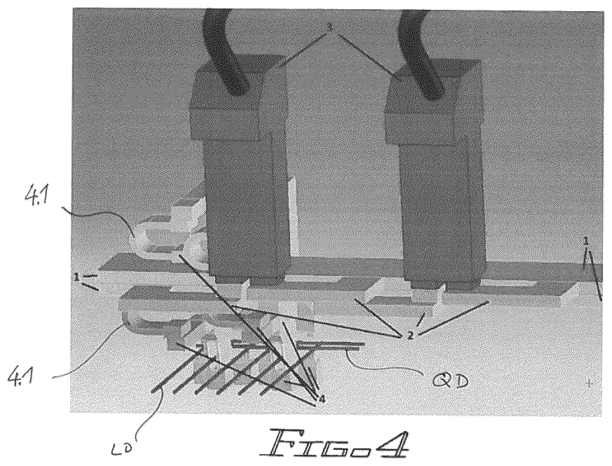

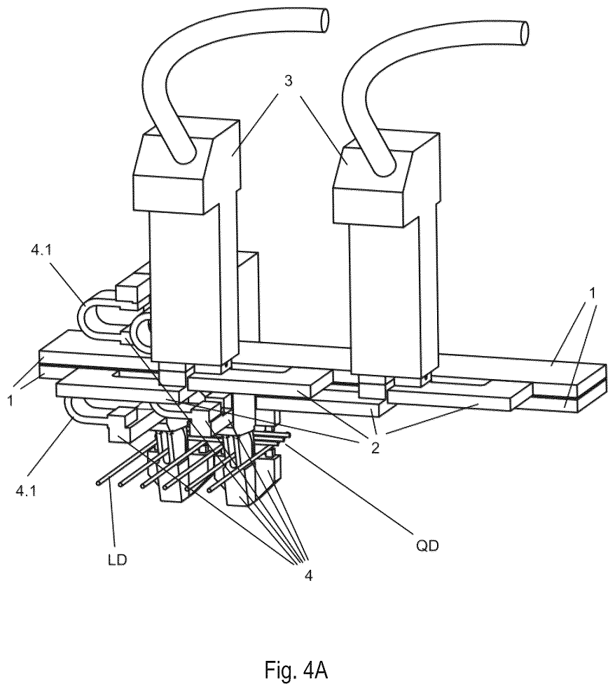

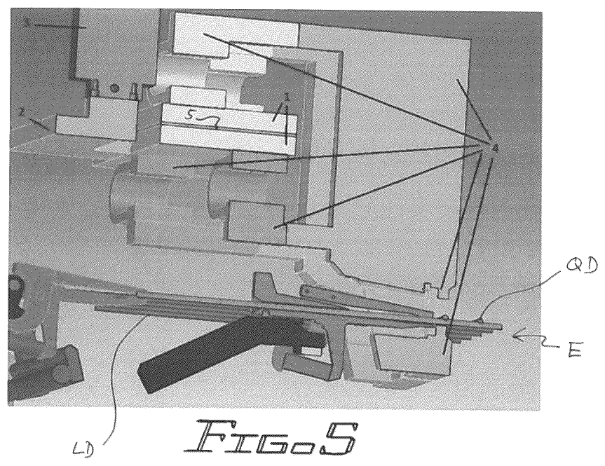

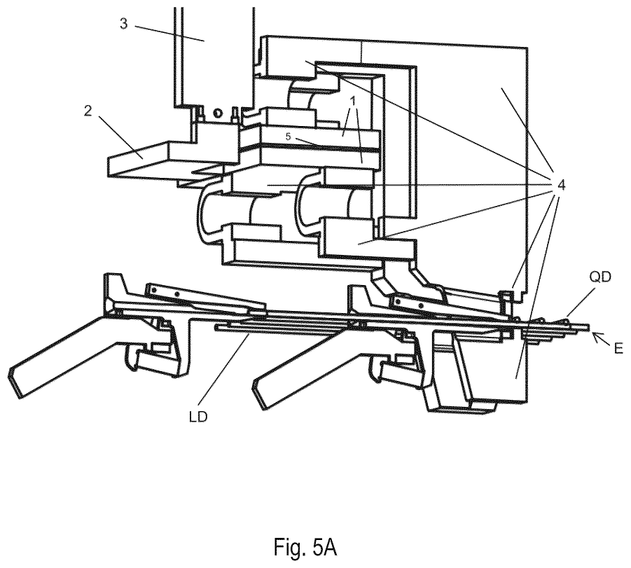

FIG. 3 to FIG. 5 and FIG. 3A to 5A illustrate the described subject matter in perspective views from other angles and with exemplary longitudinal wires LD and transverse wires QD lying in plane E.

The invention thus consists in the combination of medium-frequency welding technology with the newly designed arrangement of the two continuous busbars 1 in sandwich construction and the overlapping electrical energy input via the transformers 3, all above or below the mesh production plane E.

In this way, the further current path 4 to the welding nodes is provided by the extremely compact copper path with few contact points, which minimizes the voltage drops along the current path 4, thus ensuring the lowest possible loss (both inductive and resistive) and energy-efficient welding. Furthermore, the space required by the secondary busbar system is small compared to other welding machines, which also means that less material (especially copper) is used.

The system according to the invention also results in the following advantages with regard to the changeover times of a welding system for wire mesh mats with different pitches and/or different wire diameters. Due to the construction according to the invention, the changeover times during product changeover can be kept to a minimum, since the electrodes 7 (or the assemblies with the welding plungers) can simply be moved and repositioned in the required region. This also reduces the number of changeover steps, again saving time. Thirdly, various assemblies 4.4 for the welding electrodes (or electrode holders) were designed to simplify and shorten the process of changing the properties of wire mesh mats produced in succession.

The assembly 4.4 allows one or more welding points to be welded with just one welding plunger. This is made possible by the special design and energy input, in which the secondary welding voltage is kept constant over the entire welding width. This ensures an even distribution of current to all welding points, which in turn increases the product quality.

The compact design and the welding technology according to the invention also enable extremely energy-efficient welding. When positioned above the mesh production plane, plane E, the system is less sensitive or less accessible to contamination, especially if “above” means in the direction of gravity and potential contamination is caused by falling particles of any kind.

A positive side effect, together with the medium-frequency welding technology, is that the number of transformers 3 can be varied within a certain range according to the invention, making the welding machine perfectly adaptable to customer specifications. Due to the selected construction design, the positions of the transformers 3 can be shifted within a certain spatial range, which also allows the welding machine to be perfectly adapted to customer and product requirements.

A disadvantage of the medium-frequency welding technology is, in some cases, magnetization of the parts. However, the sandwich construction of the busbars 1 according to the invention advantageously keeps the magnetization of the potentially magnetizable components to a minimum.

### LIST OF REFERENCE NUMERALS

1 busbar
2 bridge
3 transformer
4 current path
4.1 elastic path piece
4.2 plate for upper electrodes
4.3 plate for opposite electrodes
4.4 subassembly
5 insulator
7 electrode
E plane
LD longitudinal wire
QD transverse wire

What is claimed is:

1-8. (canceled)

9. A welding device for wire meshes which extend in a plane with a predefined width and have meshes, wherein said welding device comprises multiple electrodes which are connected to transformers via current paths, wherein two busbars are connected between all current paths and transformers, which busbars extend on one side of the plane substantially over the width of a wire mesh mat, wherein the busbars are firmly connected to an interposed insulator to form a sandwich, and wherein multiple lines lead from a first group of current paths to electrodes located on the same side of the plane, and from a second group of current paths multiple lines lead to electrodes located on the opposite side of the plane.

10. The welding device for wire meshes according to claim 9, wherein the busbars have bridges which are arranged alternately along their extension and are connected between the transformers and the busbars for energy input.

11. The welding device for wire meshes according to claim 9, wherein the lines to the electrodes are designed as elongated plates, the plane of which extends in spaces between parallel longitudinal wires which can be welded in the welding device.

12. The welding device for wire meshes according to claim 9, wherein the transformers are medium-frequency transformers.

13. The welding device for wire meshes according to claim 9, wherein the busbars are connected to the plates via elastic path pieces and in that the plates can be driven movably from and to the mesh plane.

14. The welding device for wire meshes according to claim 9, wherein the electrodes are combined in multiple assemblies of at least two opposing electrodes, wherein each assembly is electrically connected to a line.

15. The welding device for wire meshes according to claim 14, wherein an assembly consists of one to several, preferably three pairs of electrodes.

16. A wire mesh welding machine with a welding device according to claim 9.
